(19) United States
(12) Patent Application Publication
(10) Pub. No.: US 2006/0052462 A1
(43) Pub. Date: Mar. 9, 2006

(54) Antifoam compositions containing dispersions of hydrophobic particles

(76) Inventor: Gerald W. Heebner, Savannah, GA (US)

Correspondence Address: INTERNATIONAL PAPER COMPANY, 6285 TRI-RIDGE BOULEVARD, LOVELAND, OH, 45140, US

(21) Appl. No.: 11/199,036

(22) Filed: Aug. 8, 2005

Related U.S. Application Data
(60) Provisional application No. 60/599,459, filed on Aug. 6, 2004.

(51) Int. Cl. B01D 19/02

(52) U.S. Cl. 516/115

(57) ABSTRACT

The invention relates to compositions that are capable of preventing foam from forming in media as well as methods of making and using the same.

The present application claims the benefit of priority under 35 USC § 119(e) to U.S. Provisional Patent Application 60/599,459, which is hereby incorporated, in its entirety, herein by reference.

### FIELD OF THE INVENTION

The invention relates to compositions that are capable of preventing foam from forming in media as well as methods of making and using the same.

### BACKGROUND OF THE INVENTION

The processes related to mining and/or refining of rock and/or ore causes the production of a foam. Traditionally, an aqueous media containing the mineral and/or rock and/or ore is present during processes related to mining and/or refining the same. The phenomenon known as foam production may occur during the processes related to mining and/or refining of many types of mineral and/or rock and/or ore. Foam production during these processes leads to multiple problems. Examples of such problems include corrosion, scaling and diminished heat transfer, as well as cavitation and overflow. Such problems result in loss of production and/or operational efficiencies.

To solve such problems, one has been known to use antifoam agents. Examples of an antifoam agent are those mentioned in U.S. Pat. No. 4,083,939, which is hereby incorporated, in its entirety, herein by reference. U.S. Pat. No. 4,083,939 relates to the use of tributoxyethylphosphate compounds as antifoaming agents, especially during the evaporative crystallization of calcined trona solutions. However, the use of tributoxyethylphosphate as an antifoaming agent of mineral, rock and/or ore is very costly and/or is not environmentally friendly.

Trona mining is one example of mineral, rock, and/or ore mining. It is well known that processes related to trona mining and refining causes undesirable foam production. Examples of trona mining and refining processes can be found in U.S. Pat. Nos. 6,322,767; 6,251,346; 5,955,043; 5,766,270; and 4,083,939, which are hereby incorporated, in their entirety, herein by reference.

To date, a low cost, environment-friendly antifoaming composition containing a renewable resource to be used in the mining and/or refining of minerals, rock, and/or ore, such as trona ore, is desired.

### SUMMARY OF THE INVENTION

One object of the invention is a composition containing the product of contacting a partial or full dispersion, emulsion, suspension, or sol of hydrophobic particles and a continuous phase, with a partial or full foam containing water. The particles may contain from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle. The particles may also contain from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle. Finally, the particles may contain not more than 75 wt % of unsaponifiable material based upon the total weight of the particle. An embodiment of this object of the invention relates to when the residues of distillation of natural oils are extracted from at least one member selected from the group consisting of resinous trees, vegetables, and tallow. An embodiment of this object of the invention relates to when there is a partial or full dispersion, emulsion, suspension, or sol of tall oil pitch, tall oil, crude tail oil, monomer, distilled tall oil, or mixtures thereof contacted with a foam containing water. An additionally embodiment of this object of the invention is when the continuous phase contains water. Also, the particles may have a size in at least one dimension ranging from 1 to 1000 nm.

An additional object of the invention is a composition containing particles containing from 30 to 70 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle. The particles may also contain from 0.3 to 15 wt % of at least one rosin acid compound selected from the group consisting of natural resin-based acids obtained from residues of distillation of natural oils, amine carboxylates and ester and nitrile compounds of these acids based upon the total weight of the particle. The particles may also contain from 5 to 40 wt % of unsaponifiable material based upon the total weight of the particle.

An additional object of the invention is a composition containing particles containing at least one ester, amide, amine carboxylate, and nitrile of at least one saturated or unsaturated, monocarboxylic aliphatic hydrocarbon having a linear, branched, and/or cyclic chain of from 8 and 24 carbon atoms, a dimer thereof, a trimer thereof, or mixtures thereof.

An additional object of the invention is a composition containing particles containing a combination of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof, and at least one rosin acid compound selected from the group consisting of natural resin-based acids obtained from residues of distillation of natural oils, amine carboxylates and ester and nitrile compounds of these acids at an amount ranging from 80 to 99.9 wt % based upon the total weight of the particle; and from 0.1 to 20 wt % of unsaponifiable material based upon the total weight of the particle.

An additional object of the invention is a composition containing the product of contacting a partial or full dispersion, emulsion, suspension, or sol of hydrophobic particles and a continuous phase, with a partial or full foam containing water. The particles may contain from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle. The particles may also contain from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle. Finally, the particles may contain not more than 75 wt % of unsaponifiable material based upon the total weight of the particle. In an additional embodiment of this invention, either the partial or full dispersion, emulsion, suspension, or sol of hydrophobic particles, or the foam may contain a base, salt and/or surfactant. In an additional embodiment, the base may be ammonium hydroxide, sodium hydroxide, and potassium hydroxide. In an additional embodiment, the foam and/or product may contain Na₂CO₃.NaHCO₃.2H₂O, hydrated complexes sodium carbonate and/or sodium bicarbonate. In yet another embodiment, the surfactant may be a nonionic surfactant such as an ethoxylated nonylphenol. In yet another embodiment, the composition may contain a freezing point suppressant, preferably an alcohol-containing compound.

Another object of the invention is a method of making a composition by contacting and/or mixing a partial or full dispersion, emulsion, suspension, or sol of hydrophobic particles and a continuous phase, with a partial or full foam containing water. The particles may contain from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle. The particles may also contain from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle. Finally, the particles may contain not more than 75 wt % of unsaponifiable material based upon the total weight of the particle. An embodiment of this object of the invention relates to when the residues of distillation of natural oils are extracted from at least one member selected from the group consisting of resinous trees, vegetables, and tallow. An embodiment of this object of the invention relates to when there is a partial or full dispersion, emulsion, suspension, or sol of tall oil pitch, tall oil, crude tail oil, monomer, distilled tall oil, or mixtures thereof contacted with a foam containing water. An additionally embodiment of this object of the invention is when the continuous phase contains water. Also, the particles may have a size in at least one dimension ranging from 1 to 1000 nm.

Another object of the invention is a method of retarding, inhibiting, reducing, and/or preventing the presence of foam in a media by contacting and/or mixing a partial or full dispersion, emulsion, suspension, or sol of hydrophobic particles and a continuous phase, with a partial or full foam containing water. The particles may contain from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle. The particles may also contain from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle. Finally, the particles may contain not more than 75 wt % of unsaponifiable material based upon the total weight of the particle. An embodiment of this object of the invention relates to when the residues of distillation of natural oils are extracted from at least one member selected from the group consisting of resinous trees, vegetables, and tallow. An embodiment of this object of the invention relates to when there is a partial or full dispersion, emulsion, suspension, or sol of tall oil pitch, tall oil, crude tail oil, monomer, distilled tall oil, or mixtures thereof contacted with a foam containing water. An additionally embodiment of this object of the invention is when the continuous phase contains water. Also, the particles may have a size in at least one dimension ranging from 1 to 1000 nm. In an additional embodiment, the amount of foam present in the media is reduced by at least 5% relative to the amount of foam present in the media beforehand and/or otherwise. In an additional embodiment, the contacting occurs in the presence of steam. In an additional embodiment, the foam further contains a sodium salt. In an additional embodiment, the sodium salt is crystallized. In yet an additional embodiment, the contacting and the crystallizing are performed concurrently.

Another object of the invention is a composition containing hydrophobic particles, a sodium salt or hydrate thereof; and water. In an embodiment of this invention, the particles contain from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle. In an additional embodiment of this invention, the particles contain from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle. In an additional embodiment of the invention, the particles may contain not more than 60 wt % of unsaponifiable material based upon the total weight of the particle. In an additional embodiment, the composition is a full and/or partial foam. In an additional embodiment, the composition is a partial or full foam, dispersion, suspension, sol, emulsion, or mixtures thereof. In an additional embodiment of the invention, the sodium salt or hydrate thereof may be sodium carbonate, sodium carbonate hydrate, sodium bicarbonate, sodium bicarbonate hydrate, and Na₂CO₃.NaHCO₃.2H₂O.

### BRIEF DESCRIPTION OF THE DRAWINGS

FIG. 1: One embodiment of the invention that demonstrates the antifoam effect of the composition according to the invention.

FIG. 2: One embodiment of the invention that demonstrates the antifoam effect of the composition according to the invention at different quantities as compared to a control and polyethylene glycol.

### DETAILED DESCRIPTION OF THE INVENTION

This application is related to the fields of chemistry and colloidal sciences which is described, for example, in Robert J. Hunter's “Introduction to Modern Colloid Science” (1993), Oxford University Press, which is which is hereby incorporated, in its entirety, herein by reference.

This application is related to the fields of mining mineral, rock an/or ore which is described, for example, in Kirk-Othmer “Encyclopedia of Chemical Technology”, fourth edition (1996), John Wiley & Sons, which is which is hereby incorporated, in its entirety, herein by reference.

The inventors have surprisingly found a composition that is relatively low cost and environmental friendly for use as an antifoam in aqueous media. This composition is a renewable resource and is especially suitable for use in the mining and/or refining of minerals, rock, and/or ore.

The composition comprises biomass and/or byproducts thereof. Thus, the composition is a renewable resource.

Biomass products, such as those byproducts of refining and processes taking advantage of natural sources are usually low cost. Examples of a biomass product may be the byproducts of paper making from trees. Accordingly, biomass products, such as those similar to black liquor solids, soaps, skimmings, as well as tall oil products such as pitch and/or distillate products thereof are examples of such biomass products. Further, such biomass products are predominantly environment friendly, especially compared to those traditional antifoaming agents utilized it the above-mentioned mining and/or refining processes.

The present invention relates to a composition containing at least one saturated or unsaturated, monocarboxylic aliphatic hydrocarbon. The saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon or derivative thereof. Since the hydrocarbon is monocarboxylic, the derivative may be any commonly known derivative of a carbonyl-containing compound known in general Organic Chemistry Textbooks, such as “Organic Chemistry”, 5th Edition, by Leroy G. Wade, which is which is hereby incorporated, in its entirety, herein by reference.

Examples of derivatives of the saturated or unsaturated, monocarboxylic aliphatic hydrocarbon may be an ester, nitrile, or amine carboxylate thereof, as well as those commonly found in black liquor solids, soaps, skimmings, as well as tall oil products such as pitch and/or distillate products thereof. Again, the saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon or derivative thereof having a linear, branched, and/or cyclic chain. Again, the saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon or derivative thereof having a linear, branched, and/or cyclic chain, a dimer thereof, a trimer thereof, or mixtures thereof. The composition may contain from 0.1 to 99.9 wt % saturated or unsaturated, monocarboxylic aliphatic hydrocarbon or derivative thereof having a linear, branched, and/or cyclic chain, a dimer thereof, a trimer thereof, or mixtures thereof based upon the total weight of the composition. If the saturated or unsaturated, monocarboxylic aliphatic hydrocarbon or derivative thereof having a linear, branched, and/or cyclic chain, a dimer thereof, a trimer thereof, or mixtures thereof is part of an antifoam composition, then the antifoam composition from 0.1 to 99.9 wt % saturated or unsaturated, monocarboxylic aliphatic hydrocarbon or derivative thereof having a linear, branched, and/or cyclic chain, a dimer thereof, a trimer thereof, or mixtures thereof based upon the total weight of the composition as well.

The amount of saturated or unsaturated, monocarboxylic aliphatic hydrocarbon or derivative thereof having a linear, branched, and/or cyclic chain, a dimer thereof, a trimer thereof, or mixtures thereof present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition. This is so even in instances where the saturated or unsaturated, monocarboxylic aliphatic hydrocarbon or derivative thereof having a linear, branched, and/or cyclic chain, a dimer thereof, a trimer thereof, or mixtures thereof is present in an antifoam composition.

The saturated or unsaturated, monocarboxylic aliphatic hydrocarbon or derivative thereof having a linear, branched, and/or cyclic chain, a dimer thereof, a trimer thereof, may be any one or more found in biomass products, such as those similar to black liquor solids, soaps, skimmings, as well as tall oil products such as pitch and/or distillate products such as tall oil fatty acid, distilled tall oil, crude tall oil, and monomer.

The saturated or unsaturated, monocarboxylic aliphatic hydrocarbon is a fatty acid. Examples of such include oleic, linoliec and/or stearic acids, including a derivative thereof; a linear, branched, and/or cyclic isomer thereof; a dimer thereof; and/or a trimer thereof.

The saturated or unsaturated, monocarboxylic aliphatic hydrocarbon or derivative thereof having a linear, branched, and/or cyclic chain, a dimer thereof, a trimer thereof, may be an acid having linear, branched, and/or cyclic C₁₈ chain. Examples of such may include linoliec and/or oleic acids or derivative thereof. Further examples may be linear, branched, and/or cyclic isomers of linoliec and/or oleic acids.

Examples of the saturated or unsaturated, monocarboxylic aliphatic hydrocarbon or derivative thereof having a linear, branched, and/or cyclic chain, a dimer thereof, a trimer thereof may be those found and described, for example in U.S. Pat. Nos. 6,875,842; 6,846,941; 6,344,573; 6,414,111; 4,519,952; and 6,623,554, which are hereby incorporated, in their entirety, herein by reference.

Finally, examples of the saturated or unsaturated, monocarboxylic aliphatic hydrocarbon or derivative thereof having a linear, branched, and/or cyclic chain, a dimer thereof, a trimer thereof may be caproic, enthanic, caprylic, capric, isodecyl, pelargonic, lauric, myristic, palmitic, oleic, linoleic, linolenic, stearic, isostearic, behenic, arachidic, arachidonic, erucic, azelaic, coconut, soya, tall oil, tallow, lard, neatsfoot, apricot, wheat germ, corn oil, cotton seed oil, ricinic, ricinoleic, rapeseed, palm kernel fatty acids, dimer acids, trimer acids, ozone acids, diacids, triacids, combinations and mixtures of these.

The present invention relates to a composition containing at least one rosin acid compound. The rosin acid compound may be selected from those natural resin-based acids, such as those obtained from residues of distillation of natural oils. The rosin acid compound may be also be derived. Since the rosin compound is an acid, the derivative may be any commonly known derivative of a carbonyl-containing compound known in general Organic Chemistry Textbooks, such as “Organic Chemistry”, 5th Edition, by Leroy G. Wade. Examples of such derivatives include, but is not limited to esters, amine carboxylates, and nitrile derivative of the rosin acid compound.

The rosin acids may include those that may be isolated from black liquor skimmings, crude tall oil, tall oil pitch, and distilled tall oil. In addition rosin acids may be those found in tall oil rosin, gum rosin and wood rosin. These naturally occurring rosins may be suitably mixtures and/or isomers of monocarboxylic tricyclic rosin acids usually containing 20 carbon atoms. The tricyclic rosin acids differ mainly in the position of the double bonds. The rosin acid may be at least one of levopimaric acid, neoabietic acid, palustric acid; abietic acid, dehydroabietic acid, seco-dehydroabietic acid, tetrahydroabietic acid, dihydroabietic acid, pimaric acid, paulstric acid, and isopimaric acid, or mixtures, isomers, and/or derivatives thereof. The rosins derived from natural sources also include rosins, i.e. rosin mixtures, modified notably by polymerisation, isomerisation, disproportionation and hydrogenation. The rosin acids may include those mentioned in U.S. Pat. Nos. 6,875,842; 6,846,941; 6,344,573; 6,414,111; 4,519,952; and 6,623,554, which are hereby incorporated, in their entirety, herein by reference.

The composition may contain from 0.1 to 99.9 wt % one rosin acid compound selected from the group consisting of natural resin-based acids obtained from residues of distillation of natural oils, amine carboxylates and ester and nitrile compounds of these acids based upon the total weight of the composition. If the one rosin acid compound selected from the group consisting of natural resin-based acids obtained from residues of distillation of natural oils, amine carboxylates and ester and nitrile compounds of these acids is part of an antifoam composition, then the antifoam composition from 0.1 to 99.9 wt % rosin acid compound selected from the group consisting of natural resin-based acids obtained from residues of distillation of natural oils, amine carboxylates and ester and nitrile compounds of these acids based upon the total weight of the composition as well.

The amount of rosin acid compound selected from the group consisting of natural resin-based acids obtained from residues of distillation of natural oils, amine carboxylates and ester and nitrile compounds of these acids present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition. This is so even in instances where the rosin acid compound selected from the group consisting of natural resin-based acids obtained from residues of distillation of natural oils, amine carboxylates and ester and nitrile compounds of these acids.

The present invention relates to a composition containing at least one unsaponifiable material. Examples of unsaponifiable materials is found, but not limited to, those described in U.S. Pat. Nos. 6,465,665; 6,462,210; and 6,297,353 which are hereby incorporated, in their entirety, herein by reference. Unsaponifiable material may be any neutral material that is not capable of being saponified, or ester thereof.

Examples of the unsaponifiable components include, but are not limited to, tocopherols, tocotrienols, carotenoids, vitamin A, vitamin K, vitamin D, lipoproteins, cholesterol, provitamins, growth factors, flavonoids, sterols, stilbenes, squalane, oryzanol and lycopene. Unsaponifiable material may include those mentioned in U.S. Pat. Nos. 6,875,842; 6,846,941; 6,344,573; 6,414,111; 4,519,952; and 6,623,554, which are hereby incorporated, in their entirety, herein by reference.

Further examples of such unsaponifiable materials are those found in plants, such as woody plants, preferably trees. Examples of such include, but are not limited to sterols, stanols, polycosanols, 3,5-sitostadiene-3-ona, 4-stigmasten-3-ona, α- and/or β-sitosterols, α- and/or β sitostanols, Campestanol, Campesterol, Cycloartenol, Docosanol, Eicosanol, Ergosterol, Escualene, Fatty alcohol esters, Sterol esters, Hexacosanol, Methylencycloartenol, Pimaral, Pimarol, Stigmasta-3-ona, Tetracosanol, etc.

The present invention relates to a composition containing not more than 75 wt % of unsaponifiable material based upon the total weight of the composition. If the unsaponifiable material is part of an antifoam composition, then the antifoam composition contains not more than 75 wt % unsaponifiable material based upon the total weight of the composition as well. The amount of unsaponifiable material present in the composition maybe 0.1, 0.2, 0.3, 0.5, 1.0, 1.5, 2.0, 3.0, 4.0, 5.0, 10, 15, 20, 25, 30, 35, 40, 45, 50, 55, 60, 65, 70, and 75 wt % based upon the total weight of the composition. This is so even in instances where the unsaponifiable material is present in an antifoam composition.

The composition may have any pH from 1 to 14, including 1, 2, 3, 4, 5, 6, 7, 8, 9, 10, 11, 12, 13, and 14, including any and all ranges and subranges therebetween. Although the composition may have any pH, the pH is basic or about 7 or greater (basic) and/or about 7 or less (acidic).

The composition may have an acid value. Preferably acid values include those greater than 10, including greater than or equal to 10, 11, 12, 13, 14, 15, 20, 25, 30, 35, 40, 45, 50, 55, 60, 65, 70, 75, 80, 85, 90, 95, 100, 105, 110, 120, 125, 130, 140, 150, 160, 170, 180, 190, and 200, including any and all ranges and subranges therebetween. Preferably, the acid value is from 10 to 150 although it may be any acid value mentioned above.

Preferably, the composition of the present invention is an antifoam composition containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the composition; from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the composition; and not more than 60 wt % of at least one unsaponifiable material based upon the total weight of the composition. All ranges and subranges within those amounts disclosed above may be utilized.

When the composition contains at least one of the hydrocarbon, rosin acid, and/or unsaponifiable material, preferably each may be from the residues of distillation of natural oils. Preferably, these natural oils are extracted from resinous trees, vegetables, and/or tallow. More preferably, the source of the hydrocarbon, rosin acid, and/or unsaponifiable material is tall oil pitch, tall oil, crude tail oil, monomer, distilled tall oil, or mixtures thereof.

The composition may include a solvent, preferably a hydrophilic solvent, such as water. When the composition includes the hydrophilic solvent, it is preferable that the hydrocarbon, rosin acid, and unsaponifiable material be in the form of a particle. The particle may be solid, semisolid, liquid. The particle may be in any state, except that of a 100% gaseous state. The particle size may have any size in any axis. Preferably, the particle may be from about 0.01 nm to about 100 microns, more preferably from about 0.1 nm to about 10 microns, and most preferably from about 1 nm from 1 to 1000 nm along at least one axis. The particle may be 1, 2, 3, 4, 5, 10, 1.5, 20, 25, 30, 35, 40, 45, 50, 55, 60, 65, 70, 75, 80, 85, 90, 100, 125, 150, 175, 200, 250, 300, 350, 400, 450, 500, 550, 600, 650, 700, 750, 800, 850, 900, 950, and 1000 nm along at least one axis. When a plurality of particles exists, the above size in any axis may be the average size in any axis.

In addition, the particle may be a colloid. The particle may be hydrophobic or hydrophilic, preferably hydrophobic. Still further, the particle may be a discontinuous phase in contact with a hydrophobic or hydrophilic continuous phase, preferably being the hydrophilic solvent. The combination of the particle and the continuous phase may form a full and/or partial solution, suspension, dispersion, emulsion, or sol.

When the composition is a dispersion, partial solution and/or suspension, the particle may be present from 0.01 to 100 wt % by weight of the composition. The particles may be present in an amount that is 0.01, 0.02, 0.05, 0.1, 0.2, 0.5, 1, 2, 5, 10, 15, 20, 25, 30, 35, 40, 45, 50, 55, 60, 65, 70, 75, 80, 85, 90, 95, and 100% by weight of the composition, including any and all ranges and subranges therein.

The composition of the present invention may contain at least one base. While any base is feasible, preferably bases include sodium, potassium or ammonium-containing bases. Specific examples my include hydroxides of sodium, potassium or ammonium. When the base is added to the composition, at least a portion of the resultant ions from the base is thought to form a salt therein. While the ions may be located anywhere within the composition, the ions may be contained within the particle, discontinuous phase, continuous phase, or entire antifoam composition mentioned above. Preferably the salt added in a manner that provides stability to the above-mentioned particle in a discontinuous phase.

The composition may contain from 0 to 20 wt % of the base, preferably less than 15 wt %, more preferably less than 10 wt % of the base based upon the total weight of the composition. The amount of base may be 0, 0.001, 0.005, 0.01, 0.05, 0.1, 0.5, 1, 2, 5, 10, 15, and 20 wt %, including any and all ranges and subranges therein.

The composition of the present invention may contain a surfactant. While ionic, cationic, anionic, amphoteric, and nonionic surfactants are suitable, the most preferred surfactants are nonionic surfactants. Examples of such surfactants are ethoxylated nonylphenols. Further examples include a nonionic and/or an anionic surfactant. Suitable nonionics are ethylene oxide adducts such as a fatty alcohol ethoxylate and a nonylphenol ethoxylate and suitable anionics are alkylarylsulphonates such as sodium dodecylbenzenesulphonate. A wide range of surfactants can be used in the composition of the present invention. A typical listing of anionic, nonionic, cationic, ampholytic and zwitterionic classes, and species of these surfactants, is given for example in U.S. Pat. Nos. 3,664,961 and 6,916,777, which are hereby incorporated, in their entirety, herein by reference. Amphoteric surfactants are also described in detail in “Amphoteric Surfactants, Second Edition”, E. G. Lomax, Editor (published 1996, by Marcel Dekker, Inc.) McCutcheon's, Emulsifiers and Detergents, Annually published by M. C. Publishing Co., and Surface Active Agents and Detergents” (Vol. I and II by Schwartz, Perry and Berch), which are hereby incorporated, in their entirety, herein by reference.

While the surfactant may be located anywhere within the composition, the surfactant may be contained within the particle, discontinuous phase, continuous phase, or entire antifoam composition mentioned above. Preferably the surfactant is added in a manner that provides stability to the above-mentioned particle in a discontinuous phase. The composition may contain from 0 to 20 wt % of the surfactant, preferably less than 15 wt %, more preferably less than 10 wt % of the base based upon the total weight of the composition. The amount of surfactant maybe 0, 0.001, 0.005, 0.01, 0.05, 0.1, 0.5, 1, 2, 5, 10, 15, and 20 wt %, including any and all ranges and subranges therein.

The composition may be required to be stable and/or perform at low temperatures. Therefore, the freezing and/or cloud point of the composition may be required to be reduced. Accordingly, the composition may include a freezing and/or cloud point suppressant. Any freezing and/or cloud point suppressant is sufficient. Preferable freezing and/or cloud point suppressants include glycols. Examples of glycols may be but is not limited to polyethylene glycols (PEG), as well as propylene and/or ethylene glycol. Further examples of solvent include alcohols and/or polyols. Examples of such alcohols include lower alkyl alcohols including isopropyl alcohol.

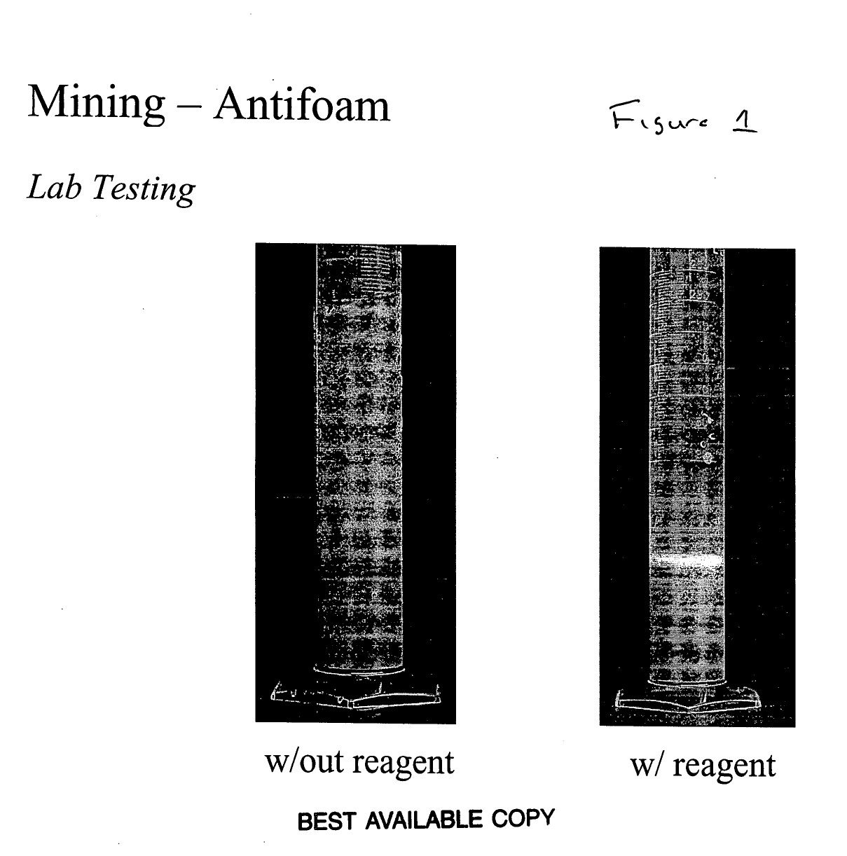

The composition of the present invention may be an antifoam for any foam-containing media. Accordingly, the antifoam composition may be added to a media being a partial and/or in whole foam. The foam may contain water, although it is not necessary. Accordingly, the present invention relates to a product of contacting the above-mentioned antifoam composition with a foam-containing media. Preferably, the foam state present in the media is reduced by at least 5% when the antifoam composition of the invention is contacted with the foam-containing media, especially when compared to a situation when the antifoam composition of the invention is not contacted with the foam-containing media. This is demonstrated clearly in FIG. 1 where the effect on the foam state is clearly a reduction when the foam-containing media is in contact with the antifoam composition. The foam state present in the media is reduced by at least 5, 10, 15, 20, 25, 30, 40, 50, 60, 70, 80, 90, 100, 125, 150, 175, 200, 300, 400, 500, 600, 700, 800, 900, and 1000%, including any and all ranges and subranges therein, when the antifoam composition of the invention is contacted with the foam-containing media, especially when compared to a situation when the antifoam composition of the invention is not contacted with the foam-containing media.

The foam-containing media may be any foam containing media. Preferably the foam-containing media is a by-product of process related to mining and/or refining mineral, rock, and/or ore. Examples of such mining include mining trona ore and similar activities that utilize chemicals that may produce sodium carbonate and/or may be utilized in a soda ash process. Another example of a utility of the present invention is towards any refining method which produces foam from steam and rapid circulation during any crystallization and/or dehydration step. Such steps may also be utilized in, but is not limited to, those utilized in processes related to mining/refining applications. Such foam may be generated from sodium carbonate production processes. Examples of such mining and/or refining of trona ore is found in U.S. Pat. Nos. 6,322,767; 6,251,346; 5,955,043; 5,766,270; and 4,083,939, which are hereby incorporated, in their entirety, herein by reference.

The composition of the present invention may contain a foam-containing media. Preferably, the foam-containing media also contains water and/or trona ore and/or by-products of refining trona ore. Trona ore is known to produce soda ash, known chemically as anhydrous sodium carbonate, is an important industrial commodity which finds extensive application in glass making and other commercial processes. Although still produced by the Solvay process in most respects, the trend in recent years is to obtain soda ash from trona ore which is principally sodium sesquicarbonate. A typical trona assay runs as follows:

| | |
|---|---|
| Na₂CO₃ | 43.51% |
| NaHCO₃ | 36.11% |
| H₂O | 13.14% |
| NaCl | 0.08% |
| Na₂SO₄ | 0.02% |
| Fe₂O₃ | 0.14% |
| Organic Matter | 0.30% |
| Insolubles | 6.70% |
| Total | 100.00% |

However, the amounts of these species may or may not always be present and may vary widely.

Although not limited to these processes, two basic commercial processes have been worked out for extracting soda ash from trona. In the sesqui process, the trona is dissolved in water, the insolubles and organic matter removed and the leach solution crystallized to give sodium sesquicarbonate, which may be used as such or subsequently calcined to soda ash. In the monohydrate process, described in U.S. Pat. No. 2,962,348 to Seglin et al., which is hereby incorporated, in its entirety, herein by reference, the crushed trona ore is calcined at the beginning, the calcined material dissolved, the solution freed of insolubles and the resulting leach solution purified, preferably by passage through columns of activated carbon. From the purified filtrate, there is formed crystalline sodium carbonate monohydrate which is separated from the mother liquor and heated to about 105° to about 125° C. to drive out water of hydration and give anhydrous sodium carbonate or soda ash. The crystallization is carried out in large evaporator-crystallizer assemblies placed in parallel. Each of the evaporators, however, is under different pressure and temperature conditions, and the heat from a high temperature evaporator (the first effect evaporator) is utilized for evaporating water from the next lower temperature evaporator.

Accordingly, the antifoam composition of the present invention may be added to any step in the mining and/or refining of trona ore, especially those that involve foam-containing media. One of the most important steps for use therein is, therefore, an evaporative, heating and/or crystallization stage, for example.

During the evaporative, heating and/or crystallization stage operation mentioned above, severe foaming often occurs, apparently due to residual impurities still present in the refined sodium carbonate solution. In any event, there is considerable foam and solution carry over with the water being evaporated resulting in such multiple problems as corrosion, scaling and diminished heat transfer. In cases of severe foaming, the evaporators have to be emptied and refilled with fresh feed; this leads to severe alkali losses and consequent economic penalties.

The present invention also relates to the product of adding the antifoam composition to a foam-containing media, so long as an effective amount of antifoam composition is added to reduce, inhibit, prevent, and/or retard foam production and/or the amount of foam present in the composition compared to those situation where the antifoam composition is not contacted with the foam-containing media.

The present invention is explained in more detail with the aid of the following embodiment examples.

### EXAMPLES

### Example 1

A composition was made by mixing the following:

| | | |
|---|---|---|
| 40 | wt % | tall oil pitch (commercially known as Unitol |
| | | DP-6 from Arizona Chemical Company) |
| 1.2 | wt % | ammonium hydroxide (10% in water) |
| 1.4 | wt % | surfactant (ethoxylated nonylphenol) |
| 57.4 | wt % | water |

### Example 2

The composition of Example 1 was first combined with 0, 5, 10, and/or 15 wt % polyethylene glycol, respectively, and then diluted to 1 wt % of the combination in water, respectively, to form antifoam compositions. Then, either 1 mL or 0.5 mL of each antifoam composition was added in accordance with the Antifoam Test provided below using trona ore. As a control, no solution was added. Also, this is compared to a 1 wt % solution of polyethylene glycol added in either 0.5 or 1 mL to the ore in accordance with the below Test in the absence of the pitch.

Antifoam Test

1. Place 90 milliliters of trona slurry solution into a 250-milliliter graduated cylinder.

2. Place an aspiration tube connected to an air source via flexible tubing into the solution in the graduated cylinder.

3. Determine the proper rate of airflow by aspirating air at a rate sufficient to maintain the foam level at the 250-milliliter mark. For convenience leave the air supply on and at the same flow rate setting. Rinse out the cylinder and the aspiration tube.

4. With a fresh sample add the specified amount of reagent and place the aspiration tube all the way to the bottom of the cylinder.

5. Record the maximum height of the foam.

6. Wash the 250-milliliter graduated cylinder and aspiration tube between samples.

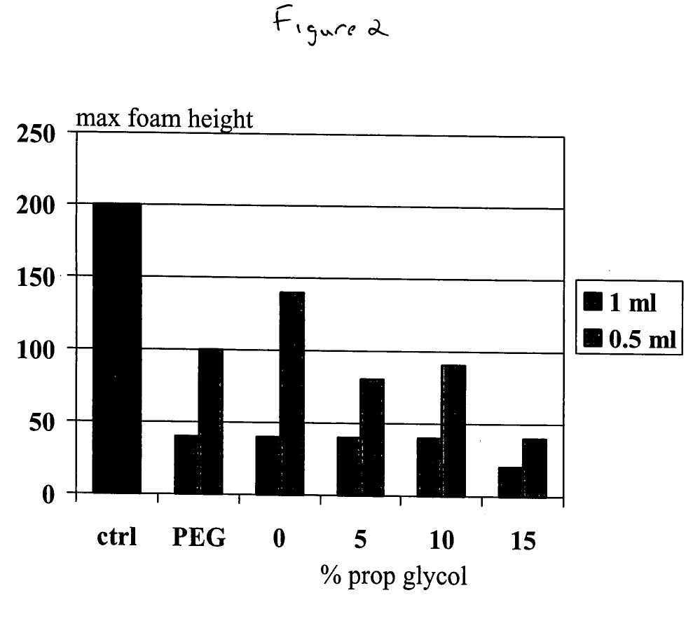

FIG. 1 demonstrates the effect of an antifoam composition in a graduated cylinder. The results of these tests are found in FIG. 2 which clearly demonstrates that the composition of the present invention, when added at 0.5 and 1.0 mL to a foam containing water and ore, retarded, reduced, and inhibited the foam remarkably as compared to those instances when no composition is added thereto. Further, the composition of the present invention with or without 5, 10, or 15 wt % polyethylene glycol outperforms polyethylene glycol alone when 1 mL is added in the assay.

As used throughout, ranges are used as a short hand for describing each and every value that is within the range, including all subranges therein.

Numerous modifications and variations on the present invention are possible in light of the above teachings. It is, therefore, to be understood that within the scope of the accompanying claims, the invention may be practiced otherwise than as specifically described herein.

The present application is related to U.S. patent application Ser. No. ______ filed on Aug. 8, 2005, and also claiming the benefit of priority under 35 USC § 119(e) to U.S. Provisional Patent Application 60/599,459. U.S. patent application Ser. No. ______ filed on Aug. 8, 2005, is hereby incorporated, in its entirety, herein by reference.

All of the references, as well as their cited references, cited herein are hereby incorporated by reference with respect to relative portions related to the subject matter of the present invention and all of its embodiments

We claim:

1. A composition, comprising
the product of contacting
a) a partial or full dispersion, emulsion, suspension, or sol comprising hydrophobic particles and a continuous phase,
wherein the particles comprise
from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle;
from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle; and
not more than 60 wt % of unsaponifiable material based upon the total weight of the particle;
with b) a partial or full foam comprising water.

2. The composition according to claim 1, wherein the residues of distillation of natural oils are extracted from at least one member selected from the group consisting of resinous trees, vegetables, and tallow.

3. The composition according to claim 1, wherein a) is a partial or full dispersion, emulsion, suspension, or sol of tall oil pitch, tall oil, crude tail oil, monomer, distilled tall oil, or mixtures thereof.

4. The composition according to claim 1, wherein the continuous phase of a) comprises water.

5. The composition according to claim 1, wherein the particles of a) have a size in at least one dimension ranging from 1 to 1000 nm.

6. The composition according to claim 1, wherein the particles of a) comprise
from 30 to 70 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle;
from 0.3 to 15 wt % of at least one rosin acid compound selected from the group consisting of natural resin-based acids obtained from residues of distillation of natural oils, amine carboxylates and ester and nitrite compounds of these acids based upon the total weight of the particle
from 5 to 40 wt % of unsaponifiable material based upon the total weight of the particle.

7. The composition according to claim 1, wherein a) comprises at least one ester, amide, amine carboxylate, and nitrite of at least one saturated or unsaturated, monocarboxylic aliphatic hydrocarbon having a linear, branched, and/or cyclic chain of from 8 and 24 carbon atoms, a dimer thereof, a trimer thereof, or mixtures thereof.

8. The composition according to claim 1, wherein the particles of a) comprise
a combination of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof, and at least one rosin acid compound selected from the group consisting of natural resin-based acids obtained from residues of distillation of natural oils, amine carboxylates and ester and nitrile compounds of these acids at an amount ranging from 80 to 99.9 wt % based upon the total weight of the particle; and
from 0.1 to 20 wt % of unsaponifiable material based upon the total weight of the particle.

9. The composition according to claim 1, wherein b) further comprises an inorganic salt.

10. The composition according to claim 1, wherein b) further comprises a sodium salt.

11. The composition according to claim 1, wherein b) further comprises Na₂CO₃.NaHCO₃.2H₂O.

12. The composition according to claim 1, wherein b) further comprises sodium carbonate.

13. The composition according to claim 1, wherein b) further comprises sodium bicarbonate.

14. The composition according to claim 1, wherein b) further comprises a gas.

15. The composition according to claim 1, further comprising c) a freezing point suppressant.

16. A method of making the composition according to claim 1, comprising contacting a) with b).

17. The composition according to claim 1, wherein a) further comprises at least one salt selected from the group consisting of ammonium hydroxide, sodium hydroxide, and potassium hydroxide.

18. The composition according to claim 1, wherein a) further comprises at least one surfactant.

19. The composition according to claim 1, wherein a) further comprises a nonionic surfactant

20. The composition according to claim 1, wherein a) further comprises ethoxylated nonylphenol.

21. A method of inhibiting, reducing, and/or preventing the presence of foam in a media, comprising
contacting a) a partial or full dispersion, emulsion, suspension, or sol comprising hydrophobic particles and a continuous phase,
wherein the particles comprise
from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle;
from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle; and
not more than 60 wt % of unsaponifiable material based upon the total weight of the particle;
with b) a partial or full foam comprising water.
wherein the amount of foam present in the media is reduced by at least 5% relative to the amount of foam present in the media when a) is not contacted with b).

22. The method according to claim 21, wherein said contacting occurs in the presence of steam.

23. The method according to claim 21, wherein b) further comprises comprises a sodium salt.

24. The method according to claim 23, further comprising crystallizing the sodium salt.

25. The method according to claim 24, wherein the contacting and the crystallizing are performed concurrently.

26. A composition, comprising
hydrophobic particles, wherein the particles comprise
from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle;
from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle; and
not more than 60 wt % of unsaponifiable material based upon the total weight of the particle;
a sodium salt or hydrate thereof; and
water.

27. The composition according to claim 26, wherein the composition is a partial or full dispersion, suspension, sol, emulsion, or mixtures thereof

28. The composition according to claim 26, wherein the composition is a partial foam.

29. The composition according to claim 26, wherein the sodium salt or hydrate thereof is at least one member selected from the group consisting of sodium carbonate, sodium bicarbonate, and Na₂CO₃.NaHCO₃.2H₂O.
